(19) United States
(12) Patent Application Publication
(10) Pub. No.: US 2025/0192479 A1
(43) Pub. Date: Jun. 12, 2025

(54) ELECTRICAL CONNECTOR HAVING A MATING ASSURANCE VERIFICATION

(71) Applicant: TE Connectivity Solutions GmbH, Schaffhausen (CH)

(72) Inventors: Nathan Philip Myer, Lancaster, PA (US); Xing Yun, Oxford, MI (US); Galen M. Martin, Mechanicsburg, PA (US); Samantha Krietemeyer, Troy, MI (US)

(21) Appl. No.: 18/740,296

(22) Filed: Jun. 11, 2024

Related U.S. Application Data
(60) Provisional application No. 63/644,589, filed on May 9, 2024.
(60) Provisional application No. 63/607,583, filed on Dec. 8, 2023.

(51) Int. Cl. H01R 13/641; H01R 13/631; H01R 13/66

(52) U.S. Cl. CPC H01R 13/641; H01R 13/631; H01R 13/6691

(57) ABSTRACT

An electrical connector includes a housing having walls extending between a terminating end and a mating end configured to be mated to a mating electrical connector. The electrical connector includes contacts held by the housing. Each contact extends between a terminating end and a mating end configured to be mated to a mating contact of the mating electrical connector. The electrical connector includes a latching element configured to be latchably coupled to a mating latching element of the mating electrical connector when the housing is fully mated to the mating electrical connector. The electrical connector includes a mated verification device coupled to the housing having a wireless communication element configured to transmit a verification signal indicative of the electrical connector being mated with the mating electrical connector.

### CROSS REFERENCE TO RELATED APPLICATIONS

This application claims benefit to U.S. Application No. 63/644,589, filed 9 May 2024, titled “ELECTRICAL CONNECTOR HAVING A MATING ASSURANCE VERIFICATION” and U.S. Application No. 63/607,583, filed 08-December-2023, titled “CONNECTOR MATING ASSURANCE VERIFICATION WITH RFID” the subject matter of which are herein incorporated by reference in their entirety.

### BACKGROUND OF THE INVENTION

The subject matter herein relates generally to electrical connectors.

Communication systems include electrical connectors, which are mated to electrically connect various components of the system. For example, a header connector may be mounted to a device, such as to a circuit board, for mating with a plug connector, which may be terminated to a wire harness or another circuit board. The electrical connectors typically include latches to secure the electrical connectors together, once mated. However, when improperly mated, the latches may separate allowing the electrical connectors to become inadvertently unmated over time. To avoid such situation, some electrical connectors include connector position assurance (CPA) devices that are used to ensure proper latching of the electrical connectors. The CPA devices are typically mechanical devices that are mechanically actuated during assembly providing visual and/or tactile feedback to the installer. However, the installer may improperly verify actuation of the CPA devices.

Some known electrical connectors use electrically activated connector verification systems that verify proper connection using electrical signals passing through a verification circuit. For example, the electrical connectors may include verification contacts in the plug connector and the header connector that are mated when the plug connector and the header connector are mated creating a verification circuit. However, the contacts may be mated without the latches being fully mated leading to false verification. Additionally, such systems increase overall cost of the communication system by redesigning the electrical connectors to include the additional contacts.

A need remains for a cost effective and reliable mating verification system for electrical connectors.

### BRIEF DESCRIPTION OF THE INVENTION

In one embodiment, an electrical connector is provided and includes a housing having walls that extends between a mating end and a terminating end. The mating end configured to be mated to a mating electrical connector. The electrical connector includes contacts held by the housing. Each contact extends between a mating end and a terminating end. The mating end of the contact configured to be mated to a mating contact of the mating electrical connector. The electrical connector includes a latching element configured to be latchably coupled to a mating latching element of the mating electrical connector when the housing is fully mated to the mating electrical connector. The electrical connector includes a mated verification device coupled to the housing. The mated verification device includes a wireless communication element configured to transmit a verification signal indicative of the electrical connector being mated with the mating electrical connector.

In another embodiment, a communication system is provided and includes a plug connector that includes a plug housing, plug contacts held by the plug housing, and a plug latch having a latching element. The communication system includes a header connector that includes a header housing, header contacts held by the header housing, and a header latch having a latching element. The header connector being mated to the plug connector at a mating interface. The communication system includes a wireless communication assembly at the mating interface. The plug housing is configured to be plugged into the header housing to mate the plug contacts with the header contacts. The latching element of the header latch interfacing with the latching element of the plug latch to latchably couple the plug connector to the header connector. The wireless communication assembly is configured to transmit a verification signal indicative of a mated status of the plug connector and the header connector.

In a further embodiment, a communication system is provided and includes a plug connector that includes a plug housing, plug contacts held by the plug housing, and a plug latch having a latching element. The plug connector includes a first wireless communication element. The communication system includes a header connector includes a header housing, header contacts held by the header housing, and a header latch having a latching element. The header connector includes a second wireless communication element. The plug housing is configured to be plugged into the header housing to mate the plug contacts with the header contacts. The latching element of the header latch interfacing with the latching element of the plug latch to latchably couple the plug connector to the header connector. The first wireless communication element and the second wireless communication element are coupled when the plug connector is coupled to the header connector to transmit a verification signal indicative of the mated status of the plug connector and the header connector.

### BRIEF DESCRIPTION OF THE DRAWINGS

FIG. 1 is a perspective view of a communication system in accordance with an exemplary embodiment.

FIG. 2 is a front perspective view of the header connector in accordance with an exemplary embodiment.

FIG. 3 is a side view of the header connector in accordance with an exemplary embodiment.

FIG. 4 is a front perspective view of the plug connector in accordance with an exemplary embodiment.

FIG. 5 illustrates one of the plug contacts in accordance with an exemplary embodiment.

FIG. 6 is a schematic view of the communication system in accordance with an exemplary embodiment showing the first and second electrical connectors in an unmated state.

FIG. 7 is a schematic view of the communication system in accordance with an exemplary embodiment showing the first and second electrical connectors in a partially mated state.

FIG. 8 is a schematic view of the communication system in accordance with an exemplary embodiment showing the first and second electrical connectors in a fully mated state.

FIG. 9 is a schematic view of the communication system in accordance with an exemplary embodiment.

FIG. 10 is a schematic view of the communication system in accordance with an exemplary embodiment.

FIG. 11 is a schematic view of the communication system in accordance with an exemplary embodiment.

FIG. 12 is a perspective view of the communication system in accordance with an exemplary embodiment.

FIG. 13 is a sectional view of a portion of the communication system showing the plug connector partially mated to the header connector in accordance with an exemplary embodiment.

FIG. 14 is a sectional view of a portion of the communication system showing the plug connector fully mated to the header connector in accordance with an exemplary embodiment.

FIG. 15 illustrates the wireless communication assembly in accordance with an exemplary embodiment.

FIG. 16 is a perspective view of the communication system in accordance with an exemplary embodiment showing the wireless communication assembly shown in FIG. 15 incorporated in the communication system.

### DETAILED DESCRIPTION OF THE INVENTION

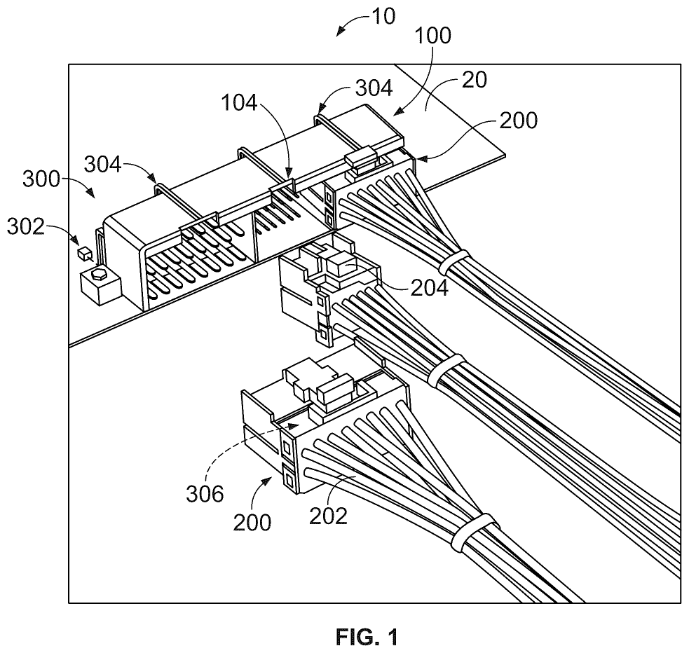

FIG. 1 is a perspective view of a communication system 10 in accordance with an exemplary embodiment. The communication system 10 includes a first electrical connector 100 and a second electrical connector 200 configured to be mated with the first electrical connector 100. The communication system 10 may include a plurality of the electrical connectors 100 and/or a plurality of the electrical connectors 200. In the illustrated embodiment, a plurality of the electrical connectors 200 configured to be mated with a single electrical connector 100. The electrical connectors 200 are mating electrical connectors for the first electrical connector 100. Similarly, the first electrical connector 100 is considered a mating electrical connector for the second electrical connectors 200.

In an exemplary embodiment, the first electrical connector 100 is a header connector and may be referred to hereinafter as header connector 100. The header connector 100 is mounted to a component, such as a host circuit board 20. However, the component may be a non-electrical component in alternative embodiments, such as a panel or wall of the device used to hold the header connector 100. In an exemplary embodiment, the header connector 100 is a board mounted connector mounted to and electrically connected to the host circuit board 20. In the illustrated embodiment, the header connector 100 is a right angle connector having the mounting end oriented perpendicular to the mated end. Other orientations are possible in alternative embodiments, such as a straight pass-through connector, such as a vertical connector. In other various embodiments, the header connector 100 is a cable connector provided at an end of one or more cables.

In an exemplary embodiment, the second electrical connector 200 is a plug connector and may be referred to hereinafter as plug connector 200. The plug connector 200 is configured to be plugged into a receptacle or socket of the header connector 100. In an exemplary embodiment, the plug connector 200 is a cable connector provided at an end of one or more cables 202. In the illustrated embodiment, the cables 202 extend from an end opposite the mating end of the plug connector 200. In other various embodiments, the plug connector 200 may be a right angle connector having the cables 202 extend perpendicular to the mating end. In other various embodiments, the plug connector 200 may be a board mounted connector configured to be mounted to a circuit board.

In an exemplary embodiment, the communication system 10 includes a mated verification system 300 that provides validation signals to provide mating assurance of the electrical connectors 100, 200. For example, the mated verification system 300 provides a verification signal to the communication system 10 when the electrical connectors 100, 200 are fully mated. When the electrical connectors 100, 200 are unmated, the mated verification system 300 does not transmit validation signals. The electrical connectors 100, 200 are fully mated when all contacts of the electrical connectors 100, 200 are mated and the latching components of the electrical connectors 100, 200 are latched. Prior to latching of the latching components, even if the contacts of the electrical connectors 100, 200 are mated, the electrical connectors 100, 200 are considered unmated. As such, the mated verification system 300 forms an electronic connector position assurance (CPA) device for the communication system 10. In various embodiments, the connectors 100, 200 may include mechanical CPA devices 104, 204, such as sliding CPA devices, configured to be actuated after the connectors 100, 200 are mated to ensure that the connectors 100, 200 are fully mated. The CPA devices 104, 204 are separate verification devices from the electronic mated verification system 300. In various embodiments, the mated verification system 300 may be integrated with the CPA devices 104, 204, such as being activated when the CPA devices 104, 204 are actuated thus forming primary and secondary CPA devices.

In an exemplary embodiment, the mated verification system 300 includes a wireless communication assembly 302 configured to communicate the validation signals wirelessly. In various embodiments, the wireless communication assembly 302 uses electromagnetic fields to transmit the digital data. In an exemplary embodiment, the wireless communication assembly 302 may include radio frequency identification (RFID) components using electromagnetic fields to communicate wirelessly. For example, the wireless communication assembly 302 includes a passive RFID component configured to transmit digital data or signals when triggered by an electromagnetic interrogation pulse from a nearby RFID reader device. The wireless communication assembly 302 may use other technologies in alternative embodiments. For example, the wireless communication assembly 302 may include near field communication (NFC) components to allow short-range wireless communication that allows for two-way communication between devices. The wireless communication assembly 302 may include barcodes or QR codes for tracking and identifying items that can be read by optical scanners. The wireless communication assembly 302 may use Bluetooth low energy (BLE) components to enable devices to communicate over short distances. The wireless communication assembly 302 ultrasound technology for proximity sensing and positioning. The wireless communication assembly 302 may use Internet of Things (IoT) sensors to track and monitor the objects.

In an exemplary embodiment, the wireless communication assembly 302 is configured to transmit the verification signal only when the electrical connectors 100, 200 are fully mated. For example, the wireless communication assembly 302 is configured to transmit the verification signal only after the latching elements are latchably coupled ensuring that the electrical connectors 100, 200 are fully mated and will remain mated. In an exemplary embodiment, the wireless communication assembly 302 becomes discoverable only after the electrical connectors 100, 200 are fully mated such that the verification signal is transmitted as verification of the electrical connectors 100, 200 being fully mated. For example, portions of the wireless communication assembly 302 may be provided on both electrical connectors 100, 200, which are only electrically connected when the electrical connectors 100, 200 are fully mated. In an exemplary embodiment, the first electrical connector 100 includes a first wireless communication element 304 and the second electrical connector 200 includes a second wireless communication element 306, which are configured to be electrically connected when the electrical connectors 100, 200 are mated. In various embodiments, the wireless communication assembly 302 may be integrated with the CPA devices 104, 204, such as being provided on the CPA devices 104, 204 and movable with the CPA devices 104, 204 configured to be activated when the CPA devices 104, 204 are actuated and/or connected.

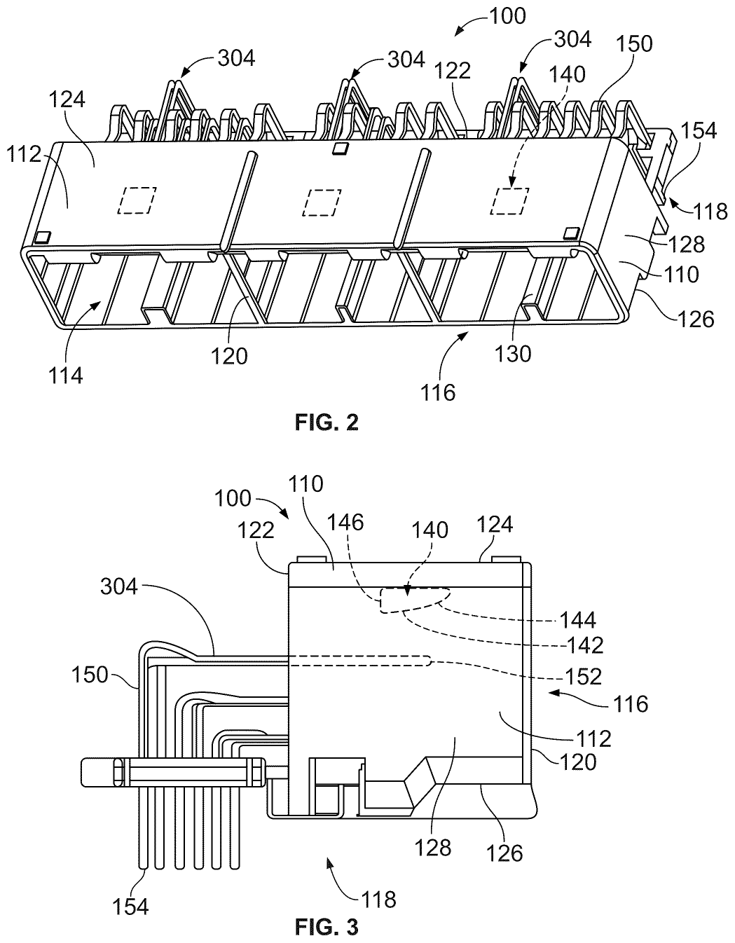

FIG. 2 is a front perspective view of the header connector 100 in accordance with an exemplary embodiment. FIG. 3 is a side view of the header connector 100 in accordance with an exemplary embodiment. In an exemplary embodiment, the header connector 100 includes the first wireless communication element 304. In various embodiments, the header connector 100 may include multiple wireless communication elements 304, such as for assuring mated connections with multiple plug connectors 200 (shown in FIG. 1).

The header connector 100 includes a header housing 110 holding a plurality of header contacts 150. The header connector 100 includes a header latch 140 (shown in phantom) having a latching element 142 used to latchably couple the plug connector 200 to the header connector 100. The header connector 100 includes the wireless communication element(s) 304.

In an exemplary embodiment, the header housing 110 is manufactured from a dielectric material. For example, the header housing 110 may be molded from a plastic material. The header housing 110 includes a plurality of walls 112 forming a cavity 114 that receives the plug connector 200. The header housing 110 extends between a mating end 116 and a terminating end 118. The plug connector 200 is configured to be coupled to the mating end 116. The cavity 114 is open at the mating end 116 to receive the plug connector 200. In an exemplary embodiment, the terminating end 118 is configured to be mounted to the host circuit board 20 (shown in FIG. 1). In alternative embodiments, the terminating end 118 is configured to be coupled to one or more cables.

The header housing 110 includes a front 120 and a rear 122. The header housing 110 includes a top 124 and a bottom 126. The header housing 110 includes sides 128 between the top 124 and the bottom 126. In an exemplary embodiment, the mating end 116 is provided at the front 120. Other locations are possible in alternative embodiments, such as the top 124. The cavity 114 is open at the front 120 to receive the plug connector 200. In the illustrated embodiment, the latch 140 is provided at the top 124. For example, the latch 140 is located along an interior surface of the top wall at the top 124 of the header housing 110. Other locations are possible in alternative embodiments. In an exemplary embodiment, the terminating end 118 is provided at the bottom 126. Other locations are possible in alternative embodiments, such as the rear 122. In an exemplary embodiment, the header housing 110 includes interior walls, such as divider walls, that divides the cavity 114 into different chambers each configured to receive a corresponding plug connector 200. The divider walls may extend between the top 124 and the bottom 126. In an exemplary embodiment, the header housing 110 includes guide features 130 to guide mating of the plug connector 200 into the cavity 114. The guide features 130 may define keying features for keyed mating with particular plug connectors 200.

The latch 140 extends from one of the walls 112 of the header housing 110, such as the top wall. Optionally, the latch 140 may be integral with the header housing 110, such as being co-molded with the header housing 110. In various embodiments, the latching feature 142 is a fixed latching feature having a ramp surface 144 and a catch surface 146. In alternative embodiments, the latching feature 142 may be a deflectable latch, such as a deflectable latch arm. In the illustrated embodiment, the latch 140 is an internal latch located at the interior of the header housing 110, such as in the cavity 114. In other various embodiments, the latch 140 may be an external latch, such as located at an exterior of the walls 112.

The header contacts 150 are coupled to the header housing 110. In an exemplary embodiment, the contacts 150 are coupled to one or more of the walls 112 of the header housing 110. For example, the contacts 150 may be coupled to the rear wall at the rear 122 of the header housing 110. In an exemplary embodiment, the contacts 150 are stamped and formed contacts. Each contact 150 extends between a mating end 152 and a terminating end 154. The mating end 152 is configured to be mated with the plug connector 200. The terminating end 154 is configured to be electrically coupled to the host circuit board 20. In an exemplary embodiment, the contact 150 is a right angle contact having the mating end 152 perpendicular to the terminating end 154. For example, the mating end 152 may extend horizontally and the terminating end 154 may extend vertically. Other orientations are possible in alternative embodiments. The mating end 152 extends through the rear wall into the cavity 114 for mating with the plug connector 200. Optionally, the contact 150 may include a pin at the mating end 152. In other embodiments, the contact 150 may include a socket or other type of mating end. The terminating end 154 extends through the bottom wall of the header housing 110 for connection to the host circuit board 20. The bottom wall may form a contact organizer used to hold relative positions of the terminating ends 154 of the contacts 150. Optionally, the terminating end 154 may include a solder tail. In other embodiments, the contact 150 may include a compliant pin or other type of terminating end. The contacts 150 may be arranged in one or more rows and one or more columns. The contacts 150 may include signal contacts and/or ground contacts and/or power contacts.

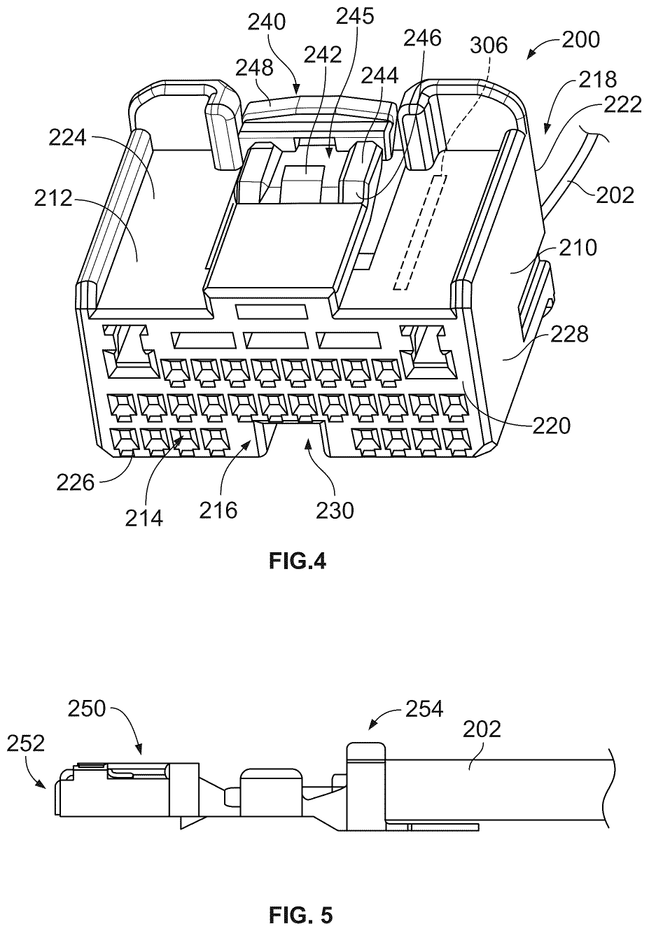

FIG. 4 is a front perspective view of the plug connector 200 in accordance with an exemplary embodiment. The plug connector 200 includes a plug housing 210 holding a plurality of plug contacts 250 (shown in FIG. 7). The plug connector 200 includes a plug latch 240 having a latching element 242 used to latchably couple the plug connector 200 to the plug connector 200. The plug connector 200 includes the wireless communication element(s) 306.

In an exemplary embodiment, the plug housing 210 is manufactured from a dielectric material. For example, the plug housing 210 may be molded from a plastic material. The plug housing 210 includes a plurality of walls 212. The plug housing 210 includes contact cavities 214 that receives the corresponding plug contacts 250. The plug housing 210 extends between a mating end 216 and a terminating end 218. The mating end 216 is configured to be plugged into the cavity 114 of the header housing 110 (shown in FIG. 2). In an exemplary embodiment, the terminating end 218 is a cable end with the cables 202 extending from the terminating end 218. In alternative embodiments, the terminating end 218 is configured to be mounted to a circuit board.

The plug housing 210 includes a front 220 and a rear 222. The plug housing 210 includes a top 224 and a bottom 226. The plug housing 210 includes sides 228 between the top 224 and the bottom 226. In an exemplary embodiment, the mating end 216 is provided at the front 220. Other locations are possible in alternative embodiments, such as the top 224. The contact cavities 214 are open at the front 220 to receive the header contacts 150. In an exemplary embodiment, the terminating end 218 is provided at the rear 222. However, the terminating end 218 may be at other locations, such as at the bottom 226. In the illustrated embodiment, the latch 240 is provided at the top 224. For example, the latch 240 is located along an exterior surface of the top wall at the top 224 of the plug housing 210. Other locations are possible in alternative embodiments. In an exemplary embodiment, the plug housing 210 includes guide features 230 to guide mating of the plug connector 200 with the header connector 100. The guide features 230 may define keying features for keyed mating with the header housing 110.

The latch 240 extends from one of the walls 212 of the plug housing 210, such as the top wall. Optionally, the latch 240 may be integral with the plug housing 210, such as being co-molded with the plug housing 210. In various embodiments, the latching feature 242 includes a deflectable latching arm 244 having a latch opening 245 that receives the latching feature 142 of the header connector 100 to latchably couple the plug connector 200 to the header connector 100. In an exemplary embodiment, the latching arm 244 includes a ramp 246 configured to engage the header connector 100, such as to deflect the latching arm 244. In the illustrated embodiment, the latch 240 includes an actuator 248, such as a push tab, used to release the latch 240.

With additional reference to FIG. 5, which illustrates one of the plug contacts 250 in accordance with an exemplary embodiment. In an exemplary embodiment, the contacts 250 are configured to be terminated to the cables 202, such as being crimped to the ends of the cables 202. The contacts 250 are configured to be received in the contact channels 214. Each plug contact 250 extends between a mating end 252 and a terminating end 254. The mating end 252 is configured to be mated with the corresponding header contact 150. In the illustrated embodiment, the mating end 252 includes a socket; however other types of contacts may be provided in alternative embodiments, such as a pin, blade, spring beam or other type of contact. The terminating end 254 is configured to be electrically coupled to the cable 202. For example, the terminating end 254 may include a crimp barrel configured to be crimped to the cable 202.

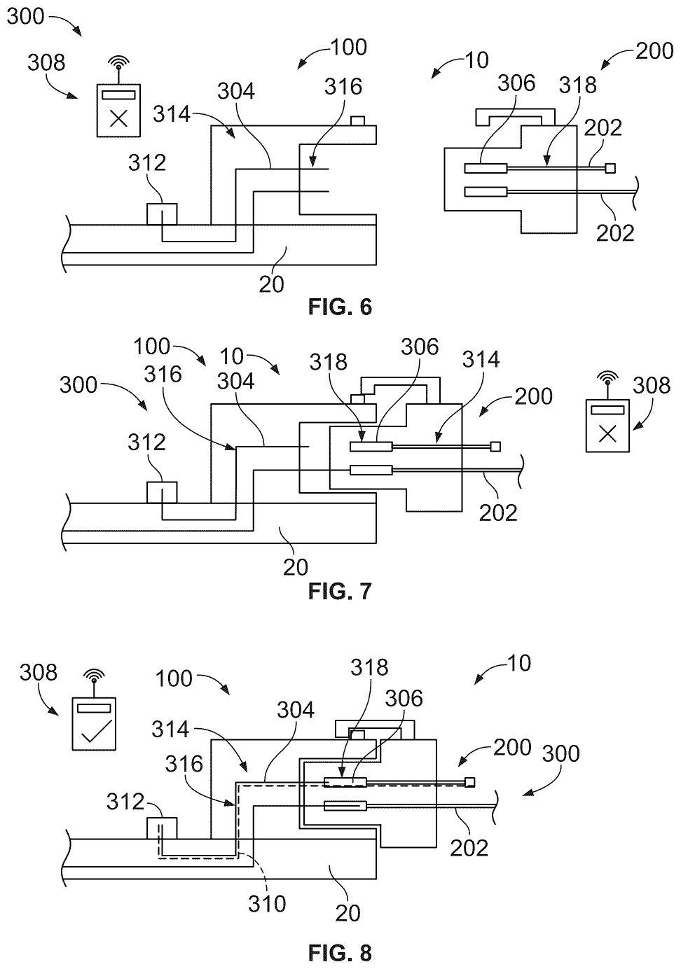

FIG. 6 is a schematic view of the communication system 10 in accordance with an exemplary embodiment showing the first and second electrical connectors 100, 200 in an unmated state. FIG. 7 is a schematic view of the communication system 10 in accordance with an exemplary embodiment showing the first and second electrical connectors 100, 200 in a partially mated state. FIG. 8 is a schematic view of the communication system 10 in accordance with an exemplary embodiment showing the first and second electrical connectors 100, 200 in a fully mated state. FIGS. 6-8 illustrate the mated verification system 300 for verifying the mated state (for example, YES/NO or Mated/Unmated) of the first and second electrical connectors 100, 200.

In an exemplary embodiment, the mated verification system 300 forms a wireless communication circuit 310 when the electrical connectors 100, 200 are mated. The wireless communication circuit 310 is open prior to fully mating the electrical connectors 100, 200. In an exemplary embodiment, the mated verification system 300 includes a reader 308 configured to interrogate the wireless communication circuit 310, such as an RFID circuit defining the wireless communication circuit 310. The wireless communication circuit 310 is undiscoverable prior to the electrical connectors 100, 200 being fully mated. For example, when the electrical connectors 100, 200 are unmated or partially mated, the wireless communication circuit 310 is undiscoverable and thus no verification signal is sent to the reader 308. After the electrical connectors 100, 200 are fully mated, the wireless communication circuit 310 is complete and discoverable and the verification signal is transmitted to the reader 308. A visual or audible indicator may be provided at the reader 308 when the verification signal is received indicating to the installer that the electrical connectors 100, 200 are fully mated. The reader 308 may communicate with another system, such as a central workstation, that the electrical connectors 100, 200 are mated. In various embodiments, the reader 308 may scan for mated verification signals from multiple electrical connectors, such as simultaneously and the central workstation may monitor the mated status of all of the connectors. For example, the reader may be incorporated into an assembly line, such as for a vehicle, monitoring mated status of many electrical connectors within the vehicle as the vehicle passes along the assembly line.

The first electrical connector 100 includes the first wireless communication element 304 and the second electrical connector 200 includes the second wireless communication element 306, which are configured to be electrically connected when the electrical connectors 100, 200 are mated. The first and second wireless communication elements 304, 306 form portions of the wireless communication circuit 310.

In an exemplary embodiment, the wireless communication circuit 310 includes one or more integrated circuit components 312 and a wireless communication antenna 314. The integrated circuit component(s) 312 may include a micro-chip. The integrated circuit component(s) 312 may stores and processes information. The information may be stored in a non-volatile memory. The integrated circuit component(s) 312 may modulate and demodulate radio-frequency (RF) signals. The integrated circuit component(s) 312 may include either fixed or programmable logic for processing the information. The wireless communication circuit 310 may include or define a wireless communication tag, such as an RFID tag. The integrated circuit component(s) 312 may be incorporated into the first electrical connector 100 and/or the second electrical connector 200. For example, the integrated circuit component(s) 312 may be incorporated into the housing of the corresponding electrical connector 100, 200. In other various embodiments, the integrated circuit component(s) 312 may be provided on other components, such as the host circuit board 20 and/or the cables 202.

The wireless communication antenna 314 receives and transmits signals, such as from/to the reader 308. The wireless communication antenna 314 may be operable at a predetermined frequency or frequency range. The size and/or shape and/or length of the wireless communication antenna 314 may control the operating frequency of the wireless communication antenna 314. In an exemplary embodiment, the first wireless communication element 304 forms a first antenna portion 316 of the wireless communication antenna 314 and the second wireless communication element 306 forms a second antenna portion 318 of the wireless communication antenna 314. Thus, the wireless communication antenna 314 is not formed until the first and second wireless communication elements 304, 306 are coupled together (for example, until the first and second electrical connectors 100, 200 are fully mated). For example, prior to mating, the size and/or shape and/or length of the wireless communication antenna 314 is too short and thus operates outside of the predetermined frequency. Thus, the wireless communication circuit 310 is not discoverable until the first and second wireless communication elements 304, 306 are coupled together (for example, until the first and second electrical connectors 100, 200 are fully mated).

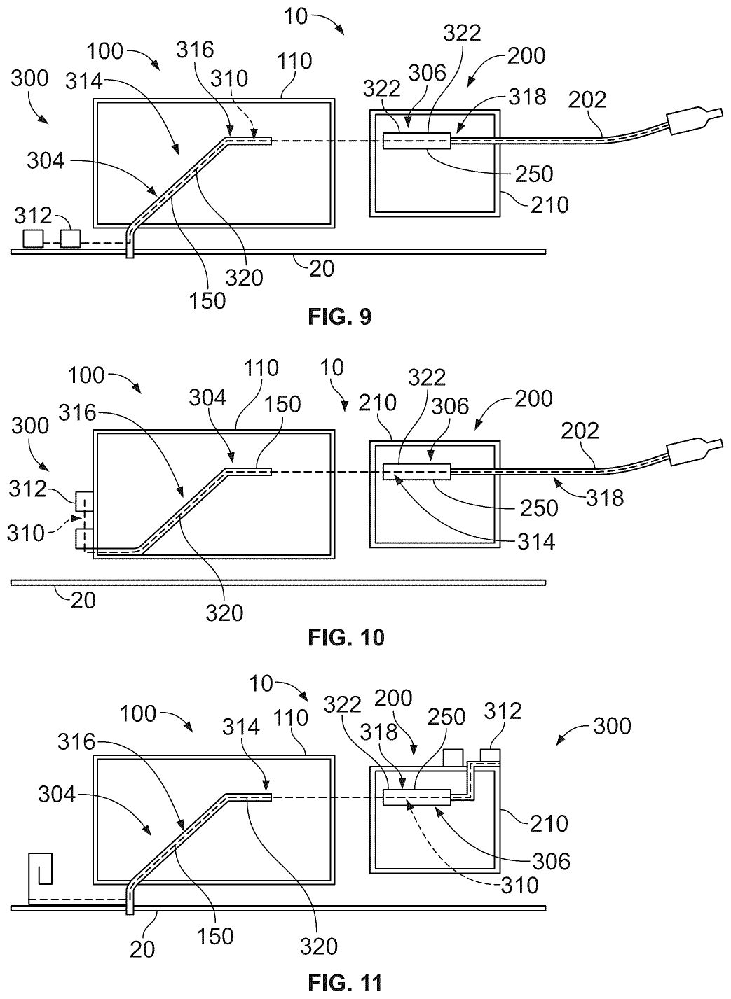

FIG. 9 is a schematic view of the communication system 10 in accordance with an exemplary embodiment. FIG. 9 shows the header connector 100 mounted to the host circuit board 20. The plug connector 200 is poised for mating with the header connector 100.

The header connector 100 includes the header housing 110 holding the header contacts 150. The header connector 100 includes the wireless communication element 304. In the illustrated embodiment, the wireless communication element 304 includes one of the header contacts 150 that defines a conductor 320 forming a portion of the wireless communication antenna 314. The conductor 320 defines the first antenna portion 316. The conductor 320 is electrically connected to the host circuit board 20. In the illustrated embodiment, the integrated circuit components 312 are coupled to the host circuit board 20. The integrated circuit components 312 are electrically connected to the conductor 320.

The plug connector 200 includes the plug housing 210 holding the plug contacts 250. The plug connector 200 includes the wireless communication element 306. In the illustrated embodiment, the wireless communication element 306 includes one of the plug contacts 250 and one of the cables 202 that defines a conductor 322 forming a portion of the wireless communication antenna 314. The conductor 322 defines the second antenna portion 318. For example, the plug contact 250 and the cable 202 form the second antenna portion 318.

Prior to the electrical connectors 100, 200 being mated, the wireless communication circuit 310 is open. For example, because the plug connector 200 is unmated from the header connector 100, the second antenna portion 318 is unmated from the first antenna portion 316. As such, the portion of the antenna circuit connected to the integrated circuit components 312 has a short length and is thus operable at a frequency outside of the operating frequency of the mated verification system 300. The wireless communication assembly 302 is undiscoverable when the second antenna portion 318 is unmated from the first antenna portion 316. When the plug connector 200 is coupled to the header connector 100, the second antenna portion 318 is coupled to the first antenna portion 316. For example, the plug contact 250 defining the conductor 322 is coupled to the header contact 150 defining the conductor 320. The antenna circuit 310 becomes discoverable after the first and second wireless communication antennas 316, 318 are connected and the total length of the wireless communication antenna 314 is connected to the integrated circuit components 312. In an exemplary embodiment, the plug contact 250 and the header contact 150 forming the wireless communication antennas 316, 318 may be last mate contacts configured to be mated only after the electrical connectors 100, 200 are fully mated (for example, after the other contacts 150, 250 are mated and after the latching elements are connected together). As such, the wireless communication circuit 310 is used as verification of the electrical connectors 100, 200 being fully mated.

FIG. 10 is a schematic view of the communication system 10 in accordance with an exemplary embodiment. FIG. 10 shows the header connector 100 mounted to the host circuit board 20. The plug connector 200 is poised for mating with the header connector 100. In the illustrated embodiment, the integrated circuit components 312 are coupled to the header housing 110 rather than the host circuit board 20.

The header connector 100 includes the header housing 110 holding the header contacts 150. The header connector 100 includes the wireless communication element 304. In the illustrated embodiment, the wireless communication element 304 includes one of the header contacts 150 that defines the conductor 320 forming a portion of the wireless communication antenna 314. The conductor 320 defines the first antenna portion 316. The conductor 320 is electrically connected to the integrated circuit components 312.

The plug connector 200 includes the plug housing 210 holding the plug contacts 250. The plug connector 200 includes the wireless communication element 306. In the illustrated embodiment, the wireless communication element 306 includes one of the plug contacts 250 and one of the cables 202 that defines the conductor 322 forming a portion of the wireless communication antenna 314. The conductor 322 defines the second antenna portion 318. For example, the plug contact 250 and the cable 202 form the second antenna portion 318.

Prior to the electrical connectors 100, 200 being mated, the wireless communication circuit 310 is open. For example, because the plug connector 200 is unmated from the header connector 100, the second antenna portion 318 is unmated from the first antenna portion 316. As such, the portion of the antenna circuit connected to the integrated circuit components 312 has a short length and is thus operable at a frequency outside of the operating frequency of the mated verification system 300. The wireless communication assembly 302 is undiscoverable when the second antenna portion 318 is unmated from the first antenna portion 316. When the plug connector 200 is coupled to the header connector 100, the second antenna portion 318 is coupled to the first antenna portion 316. For example, the plug contact 250 defining the conductor 322 is coupled to the header contact 150 defining the conductor 320. The antenna circuit 310 becomes discoverable after the first and second wireless communication antennas 316, 318 are connected and the total length of the wireless communication antenna 314 is connected to the integrated circuit components 312. In an exemplary embodiment, the plug contact 250 and the header contact 150 forming the wireless communication antennas 316, 318 may be last mate contacts configured to be mated only after the electrical connectors 100, 200 are fully mated (for example, after the other contacts 150, 250 are mated and after the latching elements are connected together). As such, the wireless communication circuit 310 is used as verification of the electrical connectors 100, 200 being fully mated.

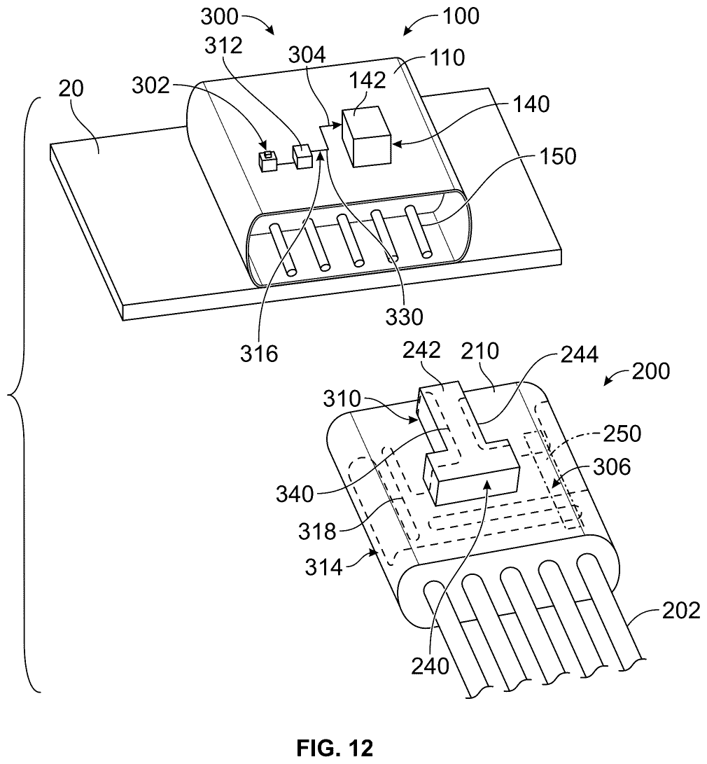

FIG. 11 is a schematic view of the communication system 10 in accordance with an exemplary embodiment. FIG. 11 shows the header connector 100 mounted to the host circuit board 20. The plug connector 200 is poised for mating with the header connector 100. In the illustrated embodiment, the integrated circuit components 312 are incorporated into the plug connector 200 rather than the header connector 100. For example, the integrated circuit components 312 may be coupled to the plug housing 210 rather than the header housing 110 or the host circuit board 20. In alternative embodiments, the integrated circuit components 312 may be coupled to the cable 202 or a circuit board provided at an end of the cable 202.

The header connector 100 includes the header housing 110 holding the header contacts 150. The header connector 100 includes the wireless communication element 304. In the illustrated embodiment, the wireless communication element 304 includes one of the header contacts 150 that defines the conductor 320 forming a portion of the wireless communication antenna 314. The host circuit board 20 may include traces forming a portion of the conductor 320 and thus a portion of the wireless communication antenna 314. The conductor 320 defines the first antenna portion 316. The The plug connector 200 includes the plug housing 210 holding the plug contacts 250. The plug connector 200 includes the wireless communication element 306. In the illustrated embodiment, the wireless communication element 306 includes one of the plug contacts 250 that defines the conductor 322 forming a portion of the wireless communication antenna 314. The conductor 322 defines the second antenna portion 318. The conductor 322 is electrically connected to the integrated circuit components 312.

Prior to the electrical connectors 100, 200 being mated, the wireless communication circuit 310 is open. For example, because the plug connector 200 is unmated from the header connector 100, the second antenna portion 318 is unmated from the first antenna portion 316. As such, the portion of the antenna circuit connected to the integrated circuit components 312 has a short length and is thus operable at a frequency outside of the operating frequency of the mated verification system 300. The wireless communication assembly 302 is undiscoverable when the second antenna portion 318 is unmated from the first antenna portion 316. When the plug connector 200 is coupled to the header connector 100, the second antenna portion 318 is coupled to the first antenna portion 316. For example, the plug contact 250 defining the conductor 322 is coupled to the header contact 150 defining the conductor 320. The antenna circuit 310 becomes discoverable after the first and second wireless communication antennas 316, 318 are connected and the total length of the wireless communication antenna 314 is connected to the integrated circuit components 312. In an exemplary embodiment, the plug contact 250 and the header contact 150 forming the wireless communication antennas 316, 318 may be last mate contacts configured to be mated only after the electrical connectors 100, 200 are fully mated (for example, after the other contacts 150, 250 are mated and after the latching elements are connected together). As such, the wireless communication circuit 310 is used as verification of the electrical connectors 100, 200 being fully mated.

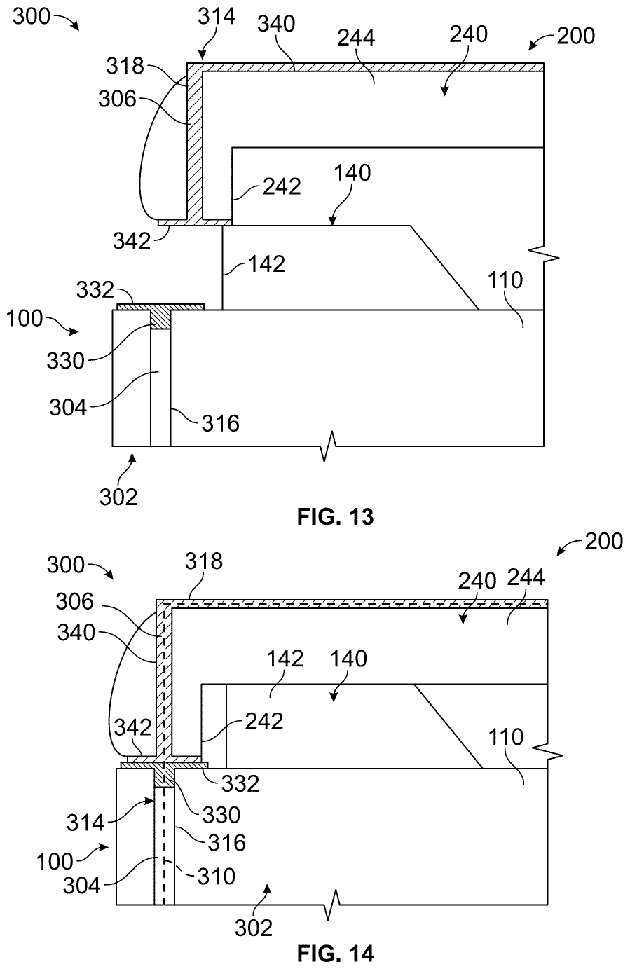

FIG. 12 is a perspective view of the communication system 10 in accordance with an exemplary embodiment. FIG. 12 shows the plug connector 200 poised for mating with the header connector 100. FIG. 13 is a sectional view of a portion of the communication system 10 showing the plug connector 200 partially mated to the header connector 100. FIG. 14 is a sectional view of a portion of the communication system 10 showing the plug connector 200 fully mated to the header connector 100. FIG. 13 shows the latching elements unmated (for example, unlatched) whereas FIG. 14 shows the latching elements mated (for example, latched).

The header connector 100 includes the header housing 110 holding the header contacts 150. The header connector 100 includes the header latch 140 having the latching element 142. The header connector 100 includes the wireless communication element 304. In the illustrated embodiment, the wireless communication element 304 includes a conductor 330 on the header housing 110 forming a portion of the wireless communication antenna 314. The conductor 330 may be a trace printed or plated onto the header housing 110, such as onto an exterior surface of the header housing 110. The conductor 330 includes a mating pad 332 proximate to the latching element 142. The conductor 320 defines the first antenna portion 316. The conductor 320 is electrically connected to the integrated circuit components 312. In the illustrated embodiment, the integrated circuit components 312 are coupled to the header housing 110.

The plug connector 200 includes the plug housing 210 holding the plug contacts 250. The plug connector 200 includes the plug latch 240 having the latching element 242. In the illustrated embodiment, the latching element 242 includes the deflectable latching arm 244. The plug connector 200 includes the wireless communication element 306. In the illustrated embodiment, the wireless communication element 306 includes a conductor 340 on the deflectable latching arm 244 and/or the plug housing 210 forming a portion of the wireless communication antenna 314. The conductor 340 defines the second antenna portion 318. The conductor 340 may be a trace printed or plated onto the plug housing 210 and/or onto the latching arm 244. The conductor 340 includes a mating pad 342, such as at a distal end of the latching arm 244. The mating pad 342 is configured to engage and be electrically connected to the mating pad 332 when the plug latch 240 is latchably coupled to the header latch 140. For example, when the latching arm 244 is in the latched position, the mating pad 342 engages the mating pad 332 to close the antenna circuit 310. In various embodiments, the wireless communication element 306 may be incorporated on a CPA device (such as the CPA devices 104, 204 shown in FIG. 1) in addition to, or in the alternative to, incorporation with the plug latch 240 and the header latch 140.

Prior to the electrical connectors 100, 200 being mated, the wireless communication circuit 310 is open. For example, because the plug connector 200 is unmated from the header connector 100, the second antenna portion 318 is unmated from the first antenna portion 316. As such, the portion of the antenna circuit connected to the integrated circuit components 312 has a short length and is thus operable at a frequency outside of the operating frequency of the mated verification system 300. The wireless communication assembly 302 is undiscoverable when the second antenna portion 318 is unmated from the first antenna portion 316. When the plug connector 200 is coupled to the header connector 100 and the plug latch 240 is latched to the header latch 140, the second antenna portion 318 is coupled to the first antenna portion 316. For example, the mating pad 342 at the distal end of the latching arm 244 is coupled to the mating pad 332 at the outer surface of the header housing 110. The antenna circuit 310 becomes discoverable after the first and second wireless communication antennas 316, 318 are connected and the total length of the wireless communication antenna 314 is connected to the integrated circuit components 312. In an exemplary embodiment, the mating pad 342 only engages the mating pad 332 when the electrical connectors 100, 200 are fully mated (for example, after the other contacts 150, 250 are mated and after the latching elements 142, 242 are connected together). As such, the wireless communication circuit 310 is used as verification of the electrical connectors 100, 200 being fully mated.

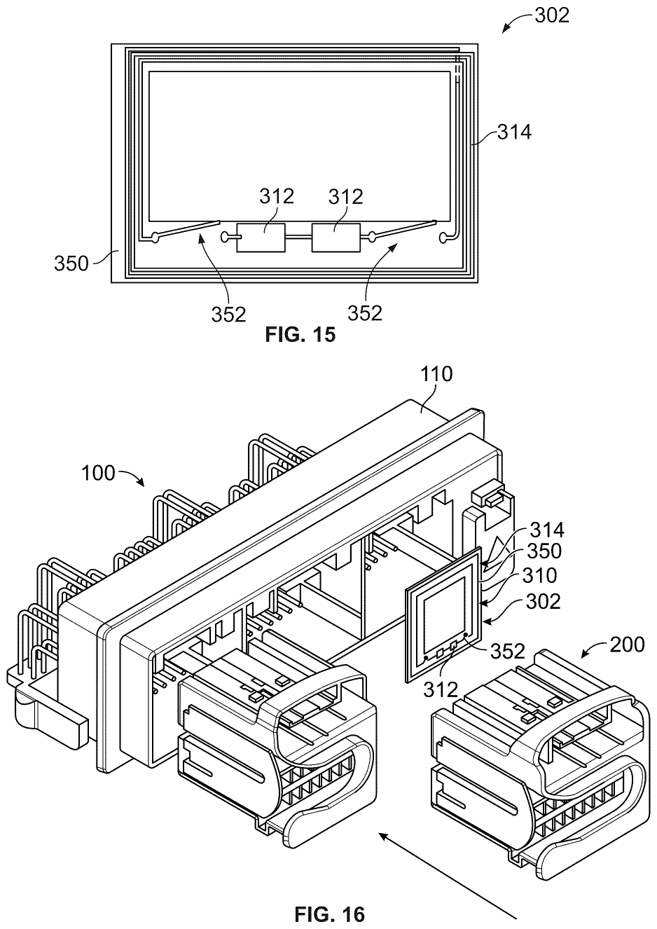

FIG. 15 illustrates the wireless communication assembly 302 in accordance with an exemplary embodiment. The wireless communication assembly 302 includes a substrate 350 holding the integrated circuit components 312. The substrate 350 supports the wireless communication antenna 314. For example, the substrate 350 may be a printed circuit board and the wireless communication antenna 314 is formed by one or more circuits of the printed circuit board, such as traces, vias, and the like. The wireless communication assembly 302 includes one or more switches 352 used to open and close the circuit forming the wireless communication antenna 314. The switches 352 may be spring contacts moveable between an open position and a closed position. The switches 352 electrically connect the integrated circuit components 312 to the wireless communication antenna 314 when closed and disconnect the integrated circuit components 312 from the wireless communication antenna 314 when open.

FIG. 16 is a perspective view of the communication system 10 in accordance with an exemplary embodiment showing the wireless communication assembly 302 shown in FIG. 15 incorporated in the communication system 10. FIG. 16 shows the plug connector 200 poised for mating with the header connector 100. The wireless communication assembly 302 is configured to be positioned between the plug connector 200 and the header connector 100. The wireless communication assembly 302 may be received in the cavity of the header housing 110. In other various embodiments, the wireless communication assembly 302 may be provided at the mating end of the plug connector 200 and configured to be plugged into the header housing 110 with the plug connector 200.

Prior to the electrical connectors 100, 200 being mated, the wireless communication circuit 310 is open. For example, the switches 352 may be open prior to the electrical connectors 100, 200 being mated. When the plug connector 200 is plugged into the header connector 100, the substrate 350 is positioned between the mating end of the plug connector 200 and the end wall of the header housing 110. The switches 352 are pressed to the closed position when the plug connector 200 is fully mated with the header connector 100 to close the antenna circuit 310. For example, the integrated circuit components 312 are connected to the wireless communication antenna 314 by the switches 352 when the switches 352 are closed. The antenna circuit 310 becomes discoverable after the switches 352 are closed (for example, when the electrical connectors 100, 200 are fully mated) As such, the wireless communication circuit 310 is used as verification of the electrical connectors 100, 200 being fully mated.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. An electrical connector comprising:
a housing having walls extending between a mating end and a terminating end, the mating end configured to be mated to a mating electrical connector;
contacts held by the housing, each contact extending between a mating end and a terminating end, the mating end of the contact configured to be mated to a mating contact of the mating electrical connector;
a latching element configured to be latchably coupled to a mating latching element of the mating electrical connector when the housing is fully mated to the mating electrical connector; and
a mated verification device coupled to the housing, the mated verification device including a wireless communication element configured to transmit a verification signal indicative of the electrical connector being mated with the mating electrical connector.

2. The electrical connector of claim 1, wherein the wireless communication element is configured to transmit the verification signal only when the electrical connector is fully mated with the mating electrical connector.

3. The electrical connector of claim 1, wherein the wireless communication element is configured to transmit the verification signal only after the latching element is latchably coupled to the mating latching element of the mating electrical connector.

4. The electrical connector of claim 1, wherein the wireless communication element becomes discoverable only after the electrical connector is fully mated with the mating electrical connector such that the verification signal is transmitted as verification of the electrical connector being fully mated with the mating electrical connector.

5. The electrical connector of claim 1, further comprising a connector position assurance (CPA) device, the wireless communication element being coupled to the CPA device.

6. The electrical connector of claim 5, wherein the CPA device is configured to be actuated between an open position and a closed position, the CPA device movable to the closed position after the latching element is latchably coupled to the mating latching element, the wireless communication element being movable with the CPA device and configured to interface with the mating electrical connector when the CPA devices in the closed position.

7. The electrical connector of claim 1, wherein the wireless communication element includes an integrated circuit element and an antenna coupled to the integrated circuit element.

8. The electrical connector of claim 1, wherein the wireless communication element includes a first antenna portion, the first antenna portion configured to be electrically connected to a second antenna portion of the mating electrical connector to form an antenna circuit to transmit the verification circuit only when the first antenna portion is electrically connected to the second antenna portion.

9. The electrical connector of claim 1, wherein the wireless communication element includes a cable coupled to a first contact of the contacts, the cable and the first contact forming portions of a wireless communication antenna.

10. The electrical connector of claim 1, wherein the wireless communication element includes conductive traces on at least one of the walls of the housing, the conductive traces forming at least a portion of a wireless communication antenna.

11. The electrical connector of claim 1, wherein the wireless communication element includes conductive traces on the latching element configured to electrically connect to a pad on the mating electrical connector when the latching element is latchably coupled to the mating latching element.

12. The electrical connector of claim 1, wherein the wireless communication element includes a wireless communication antenna and a switch coupled to the wireless communication antenna, the switch closing when the electrical connector is mated to the mating electrical connector to close a wireless communication antenna circuit of the wireless communication antenna.

13. The electrical connector of claim 1, wherein the wireless communication element includes an RFID element using electromagnetic fields for wireless communication.

14. A communication system comprising:
a plug connector including a plug housing, plug contacts held by the plug housing, and a plug latch having a latching element;
a header connector including a header housing, header contacts held by the header housing, and a header latch having a latching element, the header connector being mated to the plug connector at a mating interface; and
a wireless communication assembly at the mating interface;
wherein the plug housing is configured to be plugged into the header housing to mate the plug contacts with the header contacts, the latching element of the header latch interfacing with the latching element of the plug latch to latchably couple the plug connector to the header connector; and
wherein the wireless communication assembly is configured to transmit a verification signal indicative of a mated status of the plug connector and the header connector.

15. The communication system of claim 14, wherein the plug connector includes a first wireless communication element and the header connector includes a second wireless communication element, the first wireless communication element and the second wireless communication element being coupled when the plug connector is coupled to the header connector to transmit the verification signal.

16. The communication system of claim 15, wherein the first wireless communication element includes a first wireless communication antenna portion and the second wireless communication element includes a second wireless communication antenna portion, the first and second wireless communication antenna portions coupled to form an antenna circuit only when the plug connector is fully mated to the header connector.

17. The communication system of claim 14, wherein the wireless communication assembly is configured to transmit the verification signal only when the plug connector is fully mated with the header connector.

18. The communication system of claim 14, further comprising a connector position assurance (CPA) device configured to be actuated between an open position and a closed position, the CPA device movable to the closed position after the latching element of the plug connector is latchably coupled to the latching element of the header connector, wherein the wireless communication assembly is only able to transmit the validation signal when the CPA device is in the closed position.

19. The communication system of claim 14, wherein the wireless communication assembly includes conductive traces on at least one of the plug housing or the header housing forming at least a portion of a wireless communication antenna.

20. The communication system of claim 14, wherein the wireless communication assembly includes conductive traces on at least one of the latching element of the plug latch or the latching element of the header latch forming at least a portion of a wireless communication antenna.

21. The communication system of claim 14, wherein the wireless communication assembly includes a wireless communication antenna and a switch coupled to the wireless communication antenna, the switch closing when the plug connector is fully mated to the header connector to close a wireless communication antenna circuit of the wireless communication antenna.

22. A communication system comprising:
a plug connector including a plug housing, plug contacts held by the plug housing, and a plug latch having a latching element, the plug connector including a first wireless communication element;
a header connector including a header housing, header contacts held by the header housing, and a header latch having a latching element, the header connector including a second wireless communication element;
wherein the plug housing is configured to be plugged into the header housing to mate the plug contacts with the header contacts, the latching element of the header latch interfacing with the latching element of the plug latch to latchably couple the plug connector to the header connector; and
wherein the first wireless communication element and the second wireless communication element are coupled when the plug connector is coupled to the header connector to transmit a verification signal indicative of the mated status of the plug connector and the header connector.

23. The communication system of claim 22, wherein the first wireless communication element includes a first wireless communication antenna portion and the second wireless communication element includes a second wireless communication antenna portion, the first and second wireless communication antenna portions coupled to form an antenna circuit only when the plug connector is fully mated to the header connector.
